(19) United States
(12) Patent Application Publication
(10) Pub. No.: US 2024/0281947 A1
(43) Pub. Date: Aug. 22, 2024

(54) ANALYSIS DEVICE, ANALYSIS METHOD, AND PROGRAM

(71) Applicant: NIPPON TELEGRAPH AND TELEPHONE CORPORATION, Tokyo (JP)

(72) Inventors: Issei WAKUI, Tokyo (JP); Yasuhiro MATSUMOTO, Tokyo (JP)

(73) Assignee: NIPPON TELEGRAPH AND TELEPHONE CORPORATION, Tokyo (JP)

(21) Appl. No.: 18/565,955

(22) PCT Filed: Jun. 2, 2021
(86) PCT No.: PCT/JP2021/021084

§ 371 Date: Nov. 30, 2023

(51) Int. Cl. G06T 7/00; G06T 7/13; G06T 7/593; G06T 7/60; G06T 17/00

(52) U.S. Cl. CPC G06T 7/0002; G06T 7/13; G06T 7/593; G06T 7/60; G06T 17/00; G06T 2207/10012; G06T 2207/10028; G06T 2207/30241; G06T 2210/56

(57) ABSTRACT

An analysis device (1) according to the present invention includes an internal image input unit (11) that receives an image of the inside of a structure captured by moving a stereo camera, a 3D point cloud data generation unit (12) that generates point cloud data of an internal structure of the structure by each internal image on an image-capturing route, a first analysis unit (13) that removes point cloud data other than a deterioration prediction target from the point cloud data, and a second analysis unit (14) that extracts point cloud data in a space within a predetermined distance from a camera trajectory of the stereo camera from the point cloud data removed by the first analysis unit.

### TECHNICAL FIELD

The present disclosure relates to an analysis device, an analysis method, and a program for improving the accuracy of point cloud data.

### BACKGROUND ART

Conventionally, point cloud data having three-dimensional coordinate values is utilized to predict deterioration in a conduit (particularly, a conduit dedicated to communication cables, or the like, having a diameter in which a person can stand for laying, removing, and maintenance operations, among conduit tunnels). The point cloud data means data of a set of points handled by a computer having information such as basic X, Y, and Z position information and color. Conventionally, the following three methods have been performed for obtaining the position coordinates of the point cloud data.

The first method is a method in which a laser scanner outputs acquired data as colored point cloud data, and the position of the point cloud data is automatically corrected by simultaneous localization and mapping (SLAM). The point cloud data is acquired by reading information obtained when a laser beam emitted from a laser scanner reaches an object and is reflected. For example, NPL 1 describes a method of automatically generating a three-dimensional polygon model used for maintenance from measurement point cloud data of a civil engineering structure.

The second method is a method of generating position coordinates from an image captured by using a stereo camera using a Structure from Motion (SEM) technique. To generate high density point cloud data, a “Multi-View Stereo (MVS) multi-eye stereo” technique that is a concept of the SEM technique may be used.

The third method is a method of acquiring absolute position coordinates of the inside of a conduit by combining the plan view and the internal structure view of the conduit.

### CITATION LIST

### Non Patent Literature

[NPL 1] Hidaka Nao “Research on method of automatically generating three-dimensional polygon model used for maintenance from measurement point cloud data of civil engineering structure,” “online,” “Retrieved on May 13, 2021,” Internet <URL: https://ir.library.osaka-u.ac.jp/repo/ouka/all/69597/29788_Dissertation.pdf>, pp. 1 to 12

### SUMMARY OF INVENTION

### Technical Problem

However, there are non-coincident places in position information of a plan view, a longitudinal view, and an internal structure view of a conduit, and the plan view, the longitudinal view, and the internal structure view of the conduit have places which do not match a local structure, and thus it is difficult to evaluate an internal structure using drawing position information.

In addition, the accuracy of position information of point cloud data generated from an image of the inside of a conduit is reduced due to an image-capturing distance from a camera, the number of camera pixels, and the like.

Further, an image of the inside of a conduit has a place (a concrete wall surface part on the back side of a cable, hardware, or the like) which cannot be image-captured due to a dead angle of a camera and a place where point cloud data of a conduit concrete wall surface is not taken.

An object of the present disclosure devised in view of such circumstances is to improve the accuracy of point cloud data for deterioration prediction in analysis of an internal image and point cloud data of a structure.

### Solution to Problem

To achieve the aforementioned object, an analysis device according to an embodiment is an analysis device for generating point cloud data from an image of an inside of a structure, including: an internal image input unit configured to receive an image of an inside of a structure captured by moving a stereo camera; a 3D point cloud data generation unit configured to generate point cloud data of an internal structure of the structure by each internal image on an image-capturing route; a first analysis unit configured to removes point cloud data other than a deterioration prediction target from the point cloud data; and a second analysis unit configured to extract point cloud data in a space within a predetermined distance from a camera trajectory of the stereo camera from the point cloud data removed by the first analysis unit.

To achieve the aforementioned object, an analysis method according to an embodiment is an analysis device for generating point cloud data from an image of an inside of a structure, using an analysis device, including: a step of receiving an image of an inside of a structure captured by moving a stereo camera; a step of generating point cloud data of an internal structure of the structure by each internal image on an image-capturing route; a step of removing point cloud data other than a deterioration prediction target from the point cloud data; and a step of extracting point cloud data in a space within a predetermined distance from a camera trajectory of the stereo camera from the removed point cloud data.

To achieve the aforementioned object, a program according to an embodiment causes a computer to serve as the analysis device.

### Advantageous Effects of Invention

According to the present disclosure, it is possible to extract point cloud data with high positional accuracy suitable for quantification of a deterioration event.

### BRIEF DESCRIPTION OF DRAWINGS

FIG. 1 is a block diagram showing an example of a configuration of an analysis device according to an embodiment.

FIG. 2A is a schematic diagram for identifying a point cloud data region to be removed other than a deterioration prediction target.

FIG. 2B is a schematic diagram showing a criterion for identifying a point cloud data surface to be removed other than a deterioration prediction target.

FIG. 3A is a schematic view for describing a method of calculating a separation distance from a camera trajectory.

FIG. 3B is a diagram schematically showing a state in which a measurement error occurs.

FIG. 4 is a flowchart showing an example of an analysis method executed by the analysis device according to an embodiment.

FIG. 5 is a block diagram showing a schematic configuration of a computer serving as the analysis device.

### DESCRIPTION OF EMBODIMENTS

Hereinafter, an analysis device according to an embodiment will be described in detail. The present invention is not limited to the embodiment below and can be modified without departing from the scope of the gist of the invention.

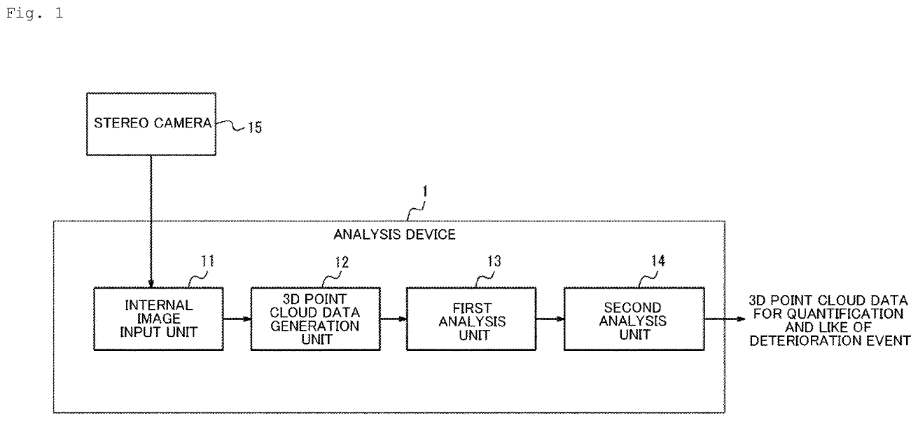

As shown in FIG. 1, an analysis device 1 according to an embodiment includes an internal image input unit 11, a 3D point cloud data generation unit 12, a first analysis unit 13, and a second analysis unit 14. The analysis device 1 is an analysis device for generating point cloud data from an image of the inside of a structure.

Before operating the analysis device 1, a place (deterioration prediction target) on which deterioration prediction will be performed in the internal structure of a structure is selected as a preliminary preparation.

The internal image input unit 11 receives an image of the inside of a structure captured by moving a stereo camera 15 and outputs the internal image of the structure to the 3D point cloud data generation unit 12.

The 3D point cloud data generation unit 12 generates point cloud data (3D point cloud data) of the internal structure of the structure by each internal image on an image-capturing route. The 3D point cloud data is generated using an SFM technique. The SFM technique refers to a generic term of a technique for restoring the shape of a target from a plurality of pictures obtained by capturing images of a target, and if SEM software is used, can easily create a 3D model by inputting the plurality of pictures. The 3D point cloud data generation unit 12 outputs the generated 3D point cloud data to the first analysis unit 13. Point cloud data has position information.

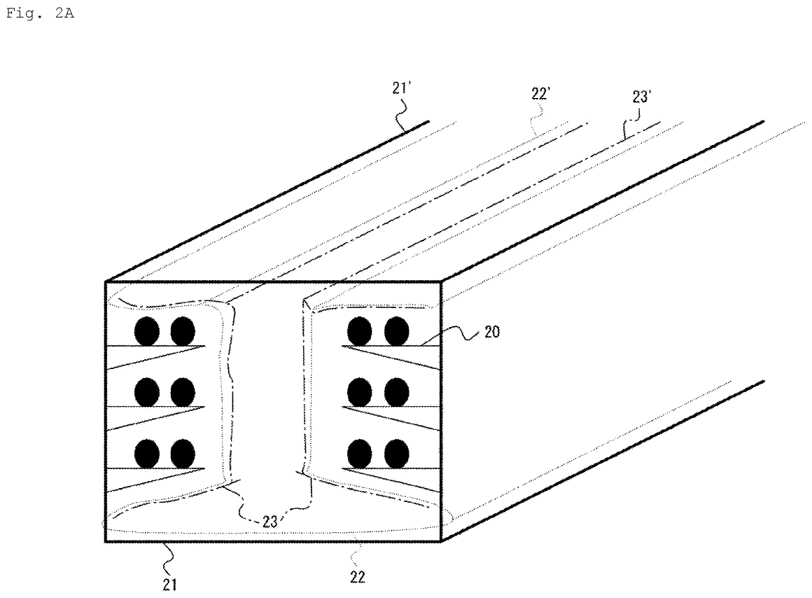

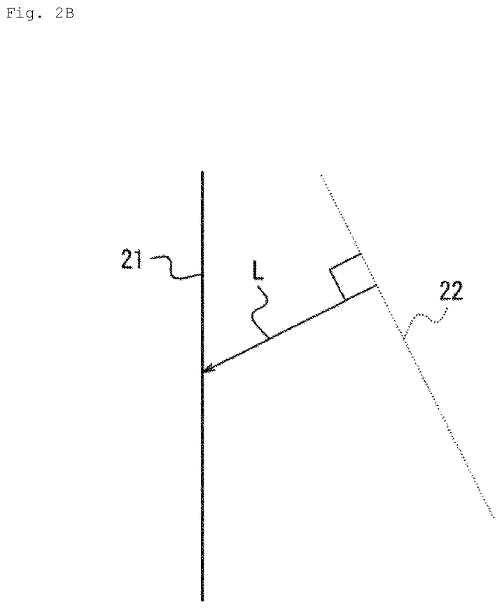

The first analysis unit 13 receives the point cloud data of the internal structure of the structure generated by the 3D point cloud data generation unit 12 and removes point cloud data other than a deterioration prediction target from the point cloud data. Further, the first analysis unit 13 outputs point cloud data obtained by removing the point cloud data other than the deterioration prediction target from the 3D point cloud data to the second analysis unit. A method of removing the point cloud data other than the deterioration prediction target will be described in detail below with reference to FIG. 2A and FIG. 2B. Although the deterioration prediction target will be described as a structure inside a tunnel hereinafter, the deterioration prediction target is not limited to a structure inside a tunnel.

In removing the point cloud data other than the deterioration prediction target, the first analysis unit 13 identifies accessories installed inside the tunnel other than the deterioration prediction target and removes point cloud data of the accessories. When the deterioration prediction target is an internal structure of the tunnel, the accessories are hardware, a cable, and the like installed in the tunnel.

For example, the first analysis unit 13 identifies a point cloud data surface in which the length of a normal line between a 2D internal cross section of the internal structure of the structure and the point cloud data surface is equal to or longer than a predetermined length and removes a region obtained by extending the identified point cloud data surface in a direction in which the structure extends. This processing will be described with reference to FIG. 2A and FIG. 2B. Although the internal structure of the structure is described below as the internal structure of a tunnel in the figure, a deterioration prediction target is not limited to thereto.

FIG. 2A is a schematic diagram for identifying a point cloud data region to be removed other than a deterioration prediction target. In FIG. 2A, a solid line represents a 2D internal cross section 21 of a tunnel and a region 21′ obtained by extending the internal cross section 21 in the direction in which the tunnel extends, a dotted line represents a 2D point cloud data surface 22 generated from an image of the inside of the tunnel and a region 22′ obtained by extending the point cloud data surface 22 in the direction in which the tunnel extends, a dashed line represents a 2D point cloud data surface 23 to be removed and a point cloud data region 23′ to be removed, obtained by extending the point cloud data surface 23 to be removed in the direction in which the tunnel extends, and black circles and triangles represent accessories (black circles are cables, and triangles are hardware).

FIG. 2B is a schematic diagram showing a criterion for identifying a point cloud data surface to be removed other than the deterioration prediction target. Specifically, as shown in FIG. 2B, the first analysis unit 13 determines whether or not the length of a normal line L extending from the point cloud data surface 22 generated from the image of the inside of the tunnel to the 2D internal cross section 21 on the image of the inside of the tunnel at a right angle is equal to or longer than a predetermined length. When the length of the normal line L is equal to or longer than the predetermined length, the first analysis unit 13 determines that the 2D internal cross section 21 and the point cloud data surface 22 are greatly separated, identifies the point cloud data surface 23 to be removed in the 2D internal cross section 21, and identifies the region 23′ obtained by extending the point cloud data surface 23 in the direction in which tunnel extends, as shown in FIG. 2A.

Further, the first analysis unit 13 may estimate a cross-sectional line shape of the deterioration prediction target hidden by accessories (cable, hardware 20, and the like shown in FIG. 2B) installed inside the tunnel from the cross-sectional line shape of the 3D point cloud data and remove point cloud data of a region obtained by extending the estimated cross-sectional line shape in the direction in which the structure extends as a point cloud data other than a structure evaluation object.

The second analysis unit 14 extracts point cloud data in a space within a predetermined distance from a camera trajectory 25 of the stereo camera 15 from the point cloud data removed by the first analysis unit 13. A method of extracting point cloud data with high position accuracy will be described below.

The second analysis unit 14 estimates a line segment corresponding to the camera trajectory 25 and extracts point cloud data in a space within a predetermined separation distance from the camera trajectory 25.

First, the line segment corresponding to the camera trajectory 25 is estimated by creating a plurality of panoramic images captured at different times from a 360-degree image, then analyzing differences in appearances of the same stationary object captured in the panoramic images, and obtaining a position of the camera.

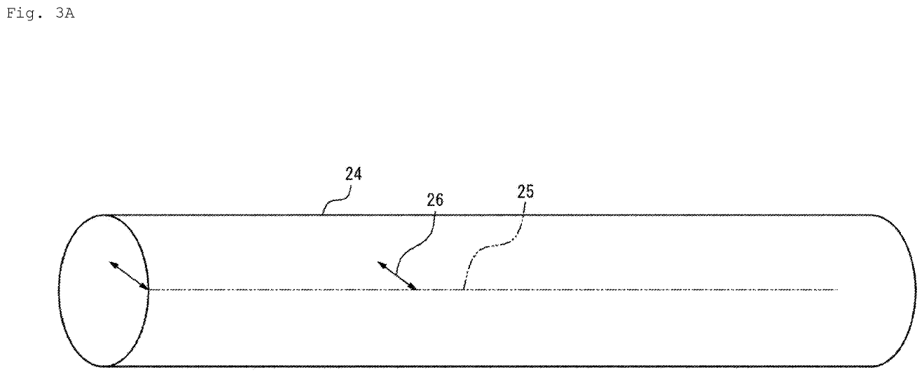

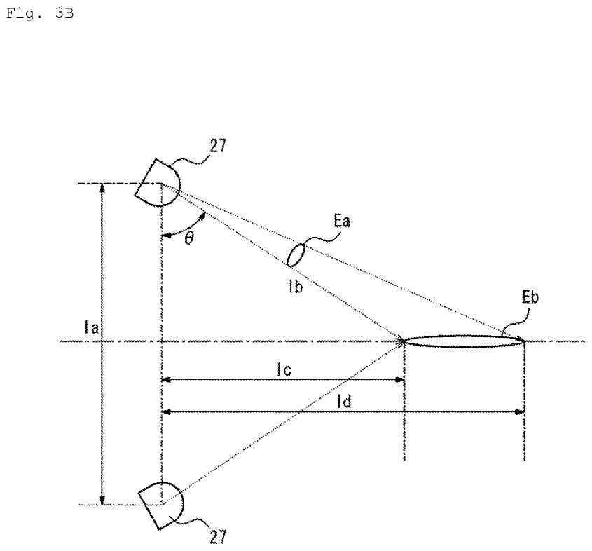

Next, the second analysis unit 14 estimates the space within the separation distance in a cylindrical shape having a camera trajectory 25 as a center axis. That is, as shown in FIG. 3A, the second analysis unit 14 estimates a specific separation distance 26 from the camera trajectory 25 in a cylindrical shape 24 and extracts point cloud data within the separation distance 26.

Alternatively, the separation distance 26 from the camera trajectory 25 may be calculated by the following formula (1). The second analysis unit 14 calculates a separation distance in which an error (measurement error) of position information of point cloud data is equal to or less than a threshold value using a base line length, the number of pixels, an angle of view, and a pixel error (angle of view/the number of pixels) of the stereo camera 15. FIG. 3B shows the relationship of the base line length, the number of pixels, the angle of view, the pixel error, and the like of the camera. The camera trajectory 25 is in a direction perpendicular to the paper surface in FIG. 3B. In FIG. 3B, the baseline length which is a distance between left and right lenses 27 in the stereo camera 15 is denoted by 1a, a camera distance from a lens to an object is denoted by 1b, a separation distance is denoted by 1c, a separation distance in consideration of a measurement error is denoted by id, a camera angle is denoted by 0, a pixel error is denoted by Ea, and the measurement error is denoted by Eb. Since the lens 27 of the stereo camera has the pixel error Ea which is a deviation of an angle to the object, the measurement error Eb is also generated in the separation distance 1c and the position of the object may be seen to be deviated. Regarding an error (measurement error) of position information of point cloud data, once the accuracy to be secured is determined, other variables are determined by a camera that has captured an image, and thus a separation distance from the camera trajectory can be calculated. Then, point cloud data in the space within the separation distance calculated from the formula (1) is extracted.

[Math. 1]

$$Separation distance = \frac{base line length}{2} \times tan ( camera angle \pm \frac{angle of view}{number of pixels} ) ∓ measurement error \qquad ( 1 )$$

A measurement accuracy in a stereo image is determined by a length actually corresponding to one pixel in the image. In other words, the measurement accuracy varies according to the resolution, the image-capturing distance, and the base line length (inter-camera distance) of the lens/camera. Further, since a point pixel corresponding to stereo in a camera imaging plate has a size, a measurement target point can be identified only as a certain range in an actual space, and thus the range becomes a measurement error. FIG. 3B is a diagram schematically showing a state in which the aforementioned measurement error occurs.

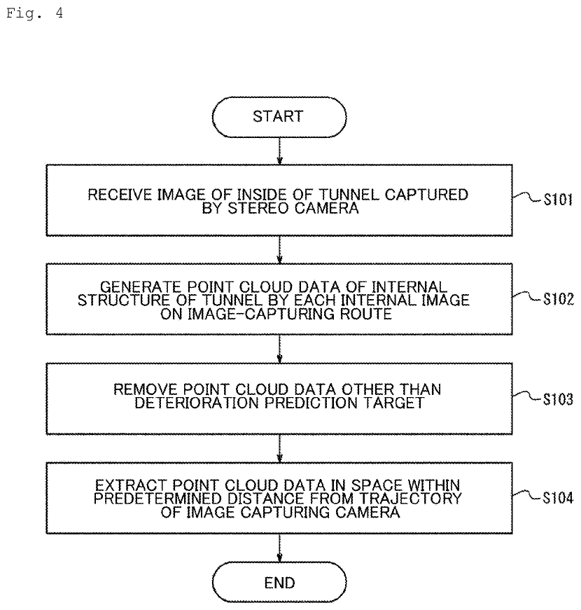

FIG. 4 is a flowchart showing an example of an analysis method executed by the analysis device 1 according to an embodiment.

Before the analysis device 1 executes the analysis method, a tunnel place (deterioration prediction target) on which deterioration prediction will be performed is selected as a preliminary preparation.

In step S101, the internal image input unit 11 receives an image of the inside of a tunnel captured by moving the stereo camera 15.

In step S102, the 3D point cloud data generation unit 12 generates point cloud data of a tunnel internal structure by each internal image on an image-capturing route.

In step S103, the first analysis unit 13 removes point cloud data other than the deterioration prediction target from the point cloud data.

In step S104, the second analysis unit 14 extracts point cloud data in a space within a predetermined distance from a camera trajectory of the stereo camera 15 from the removed point cloud data.

According to the analysis device 1, since point cloud data in a space within a predetermined distance from the camera trajectory of the stereo camera 15 is extracted, point cloud data with high position accuracy suitable for quantification of a deterioration event can be extracted.

The internal image input unit 11, the 3D point cloud data generation unit 12, the first analysis unit 13, and the second analysis unit 14 in the analysis device 1 constitute a part of a control device (controller). The control device may be configured by dedicated hardware such as an application specific integrated circuit (ASIC) or a field-programmable gate array (FPGA), may be configured by a processor, or may be configured by including both.

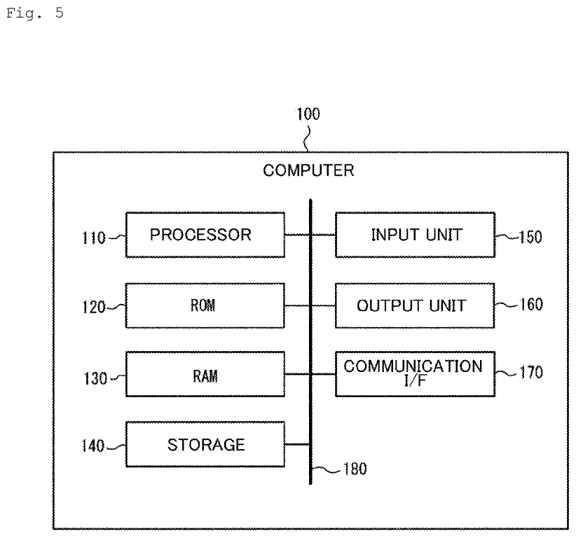

Further, a computer capable of executing program instructions can also be used to serve as the analysis device 1 described above. FIG. 5 is a block diagram showing a schematic configuration of a computer serving as the analysis device 1. Here, the computer 100 may be a general-purpose computer, a dedicated computer, a workstation, a personal computer (PC), an electronic notepad, or the like. The program instructions may be program codes, code segments, or the like for executing necessary tasks.

As shown in FIG. 5, the computer 100 includes a processor 110, a read only memory (ROM) 120, a random access memory (RAM) 130, and a storage 140 as a storage unit, an input unit 150, an output unit 160, and a communication interface (I/F) 170. The components are communicatively connected to each other via a bus 180. The internal image input unit 11 in the analysis device 1 may be constructed as the input unit 150.

The ROM 120 stores various programs and various types of data. The RAM 130 is a work area and temporarily stores a program or data. The storage 140 is configured by a hard disk drive (HDD) or a solid state drive (SSD) and stores various programs including an operating system and various types of data. In the present disclosure, the ROM 120 or the storage 140 stores a program according to the present disclosure.

The processor 110 is specifically a central processing unit (CPU), a micro processing unit (MPU), a graphics processing unit (GPU), a digital signal processor (DSP), a system on a chip (SoC), or the like and may be composed of multiple processors of the same type or different types. The processor 110 reads a program from the ROM 120 or the storage 140 and executes the program using the RAM 130 as a work area to perform control of each of the aforementioned components and various types of arithmetic processing. At least a part of such processing may be realized by hardware.

The program may also be recorded on a recording medium readable by the computer 100. Using such a recording medium, it is possible to install the program in the computer 100. Here, the recording medium on which the program is recorded may be a non-transitory recording medium. Although not particularly limited, the non-transitory recording medium may be a CD-ROM, a DVD-ROM, a Universal Serial Bus (USB) memory, or the like. Further, this program may be downloaded from an external device via a network.

The following additional remarks are disclosed in relation to the embodiments described above.

### (Supplement 1)

An analysis device for generating point cloud data from an image of an inside of a structure, including a control unit configured to receive an image of an inside of a structure captured by moving a stereo camera, to generate point cloud data of an internal structure of the structure by each internal image on an image-capturing route, to remove point cloud data other than a deterioration prediction target from the point cloud data, and to extract point cloud data in a space within a predetermined distance from a camera trajectory of the stereo camera from the removed point cloud data.

### (Supplement 2)

The analysis device according to the supplement 1, wherein the control unit estimates a line segment corresponding to the camera trajectory and extracts point cloud data in a space within a predetermined separation distance from the camera trajectory.

### (Supplement 3)

The analysis device according to the supplement 1, wherein the control unit estimates the space within the separation distance in a cylindrical shape with the camera trajectory as a center axis.

### (Supplement 4)

The analysis device according to the supplement 2, wherein the control unit calculates the separation distance in which an error of position information of the point cloud data is equal to or less than a threshold value by using a base line length, a number of pixels, an angle of view, and a pixel error of the camera.

### (Supplement 5)

An analysis method of generating point cloud data from an image of an inside of a structure, using an analysis device, including:
a step of receiving an image of an inside of a structure captured by moving a stereo camera; a step of generating point cloud data of an internal structure of the structure by each internal image on an image-capturing route; a step of removing point cloud data other than a deterioration prediction target from the point cloud data, and a step of extracting point cloud data in a space within a predetermined distance from a camera trajectory of the stereo camera from the removed point cloud data.

### (Supplement 6)

A non-transitory storage medium storing a program executable by a computer, the non-transitory storage medium storing a program causing the computer to serve as the analysis device according to any one of the supplements 1 to 4.

Although the above-described embodiment has been introduced as a typical example, it is clear for a person skilled in the art that many alterations and substitutions are possible within the gist and scope of the present disclosure. Therefore, the embodiment described above should not be interpreted as limiting and the present invention can be modified and altered in various ways without departing from the scope of the claims. For example, a plurality of configuration blocks shown in the configuration diagrams of the embodiments may be combined to one, or one configuration block may be divided.

### REFERENCE SIGNS LIST

1 Analysis device
11 Internal image input unit
12 3D point cloud data generation unit
13 First analysis unit
14 Second analysis unit
100 Computer
110 Processor
120 ROM
130 RAM
140 Storage
150 Input unit
160 Output unit
170 Communication interface (I/F)
180 Bus

1. An analysis device for generating point cloud data from an image of an inside of a structure, the analysis device comprising a processor configured to execute operations comprising:
receiving an image of an inside of a structure captured by moving a stereo camera;
generating first point cloud data of an internal structure of the structure by each internal image on an image-capturing route;
removing second point cloud data other than a deterioration prediction target from the first point cloud data; and
extracting third point cloud data in a space within a predetermined distance from a camera trajectory of the stereo camera from the removed second point cloud data.

2. The analysis device according to claim 1, wherein the extracting further comprises:
estimating a line segment corresponding to the camera trajectory, and
extracting the third point cloud data in a space within a predetermined separation distance from the camera trajectory.

3. The analysis device according to claim 1, wherein the extracting further comprises estimating the space within a separation distance in a cylindrical shape with the camera trajectory as a center axis.

4. The analysis device according to claim 2, wherein the extracting further comprises calculating the predetermined separation distance in which an error of position information of the third point cloud data is equal to or less than a threshold value by using a base line length, a number of pixels, an angle of view, and a pixel error of the stereo camera.

5. An analysis method of generating point cloud data from an image of an inside of a structure,
comprising:
receiving an image of an inside of a structure captured by moving a stereo camera;
generating first point cloud data of an internal structure of the structure by each internal image on an image-capturing route;
removing second point cloud data other than a deterioration prediction target from the first point cloud data; and
extracting third point cloud data in a space within a predetermined distance from a camera trajectory of the stereo camera from the removed second point cloud data.

6. A computer-readable non-transitory recording medium storing computer-executable program instructions that when executed by a processor cause a computer system to:
receive an image of an inside of a structure captured by moving a stereo camera;
generate first point cloud data of an internal structure of the structure by each internal image on an image-capturing route;
remove second point cloud data other than a deterioration prediction target from the second point cloud data; and
extract third point cloud data in a space within a predetermined distance from a camera trajectory of the stereo camera from the removed second point cloud data.

7. The analysis device according to claim 1, wherein the structure includes a conduit.

8. The analysis device according to claim 1, wherein the extracted third point cloud represents the deterioration prediction target for predicting deterioration of the structure.

9. The analysis device according to claim 1, wherein the predetermined distance is based at least on a base line length, a camera angle, and an angle of view of the stereo camera.

10. The analysis method according to claim 5, wherein the extracting further comprises:
estimating a line segment corresponding to the camera trajectory, and
extracting the third point cloud data in a space within a predetermined separation distance from the camera trajectory.

11. The analysis method according to claim 5, wherein the extracting further comprises estimating the space within a separation distance in a cylindrical shape with the camera trajectory as a center axis.

12. The analysis method according to claim 10, wherein the extracting further comprises calculating the predetermined separation distance in which an error of position information of the third point cloud data is equal to or less than a threshold value by using a base line length, a number of pixels, an angle of view, and a pixel error of the stereo camera.

13. The analysis method according to claim 5, wherein the structure includes a conduit.

14. The analysis method according to claim 5, wherein the extracted third point cloud represents the deterioration prediction target for predicting deterioration of the structure.

15. The analysis method according to claim 5, wherein the predetermined distance is based at least on a base line length, a camera angle, and an angle of view of the stereo camera.

16. The computer-readable non-transitory recording medium according to claim 6, wherein the extracting further comprises:
estimating a line segment corresponding to the camera trajectory, and
extracting the third point cloud data in a space within a predetermined separation distance from the camera trajectory.

17. The computer-readable non-transitory recording medium according to claim 6, wherein the extracting further comprises estimating the space within a separation distance in a cylindrical shape with the camera trajectory as a center axis.

18. The computer-readable non-transitory recording medium according to claim 16, wherein the extracting further comprises calculating the predetermined separation distance in which an error of position information of the third point cloud data is equal to or less than a threshold value by using a base line length, a number of pixels, an angle of view, and a pixel error of the stereo camera.

19. The computer-readable non-transitory recording medium according to claim 6, wherein the structure includes a conduit.

20. The computer-readable non-transitory recording medium according to claim 6, wherein the extracted third point cloud represents the deterioration prediction target for predicting deterioration of the structure, and
wherein the predetermined distance is based at least on a base line length, a camera angle, and an angle of view of the stereo camera.
